(19) United States
(12) Patent Application Publication
(10) Pub. No.: US 2020/0293005 A1
(43) Pub. Date: Sep. 17, 2020

(54) MACHINE TOOL, PROCESSING SYSTEM AND MANAGEMENT SYSTEM

(71) Applicant: Fanuc Corporation, Yamanashi (JP)

(72) Inventors: Tomohiro OYAMADA, Yamanashi (JP); Rikizou WATANABE, Yamanashi (JP)

(73) Assignee: Fanuc Corporation, Yamanashi (JP)

(21) Appl. No.: 16/785,928

(22) Filed: Feb. 10, 2020

(30) Foreign Application Priority Data
Mar. 13, 2019 (JP) 2019-045563

(51) Int. Cl. G05B 13/02; B23Q 3/157

(52) U.S. Cl. CPC G05B 13/024; G05B 13/0265; B23Q 3/157

(57) ABSTRACT

A machine tool according to the present invention includes: a turret capable of holding a plurality of tools; a spindle that selectively holds one of the plurality of tools held by the turret; a control unit that controls the operation of the turret and the spindle in accordance with a control parameter; a weight acquisition unit that, every time one tool is attached to the turret, acquires a weight of the attached one tool; and a weight setting unit that sets the weight acquired by the weight acquisition unit or an index associated with said weight in the control unit in association with the attached one tool, wherein the control unit sets the control parameter on the basis of the weights of the individual tools, which are set by the weight setting unit.

### CROSS-REFERENCE TO RELATED APPLICATIONS

This application is based on Japanese Patent Application No. 2019-045563, the contents of which are incorporated herein by reference.

### TECHNICAL FIELD

The present invention relates to a machine tool, a processing system and a management system.

### BACKGROUND ART

In the related art, there is a known machine tool that includes a turret capable of holding a plurality of tools and that automatically exchanges tools between a spindle and the turret (for example, see Patent Literatures 1-3).

### CITATION LIST

### Patent Literature

### {PTL 1} Japanese Unexamined Patent Application, Publication No. 2015-054370

### {PTL 2} Japanese Unexamined Patent Application, Publication No. 2009-34794

### {PTL 3} Japanese Unexamined Patent Application, Publication No. 2015-054355

### SUMMARY OF INVENTION

Although the weights of tools held by a turret vary, control parameters of a machine tool are set regardless of the weights of the individual tools. For example, the moving speed of a spindle during exchange of tools between the turret and the spindle is the same regardless of the weight of the tool being held by the spindle.

An aspect of the present disclosure is a machine tool including: a turret capable of holding a plurality of tools; a spindle that selectively holds one of the plurality of tools held by the turret; a control unit that controls the operation of the turret and the spindle in accordance with a control parameter; a weight acquisition unit that, every time one tool is attached to the turret, acquires a weight of the attached one tool; and a weight setting unit that sets the weight acquired by the weight acquisition unit or an index associated with said weight in the control unit in association with the attached one tool, wherein the control unit sets the control parameter on the basis of the weights of the individual tools, which are set by the weight setting unit.

### BRIEF DESCRIPTION OF DRAWINGS

FIG. 1 is a front view of a machine tool according to one embodiment.

FIG. 2 is a side view of the machine tool in FIG. 1.

FIG. 3 is an internal configuration diagram of a turret of the machine tool in FIG. 1.

FIG. 4 is a functional block diagram of a control device of the machine tool in FIG. 1.

FIG. 5 is an example of load reference data of a rotary motor of the turret.

FIG. 6 is an example of load data of the rotary motor of the turret when holding a 1.0 kg tool.

FIG. 7 is an example of load data of the rotary motor of the turret when holding a 1.0 kg tool and when holding a 3.7 kg tool.

FIG. 8 is a partially enlarged view of the graph in FIG. 7.

FIG. 9 is a diagram showing a connection between an external device and a machine tool according to another embodiment.

FIG. 10 is a diagram showing a connection between an external device and a machine tool according to another embodiment.

FIG. 11 is a block diagram of a management system according to another embodiment.

FIG. 12 is a block diagram of a management system according to another embodiment.

### DESCRIPTION OF EMBODIMENT

A machine tool 1 according to one embodiment will be described below with reference to the drawings.

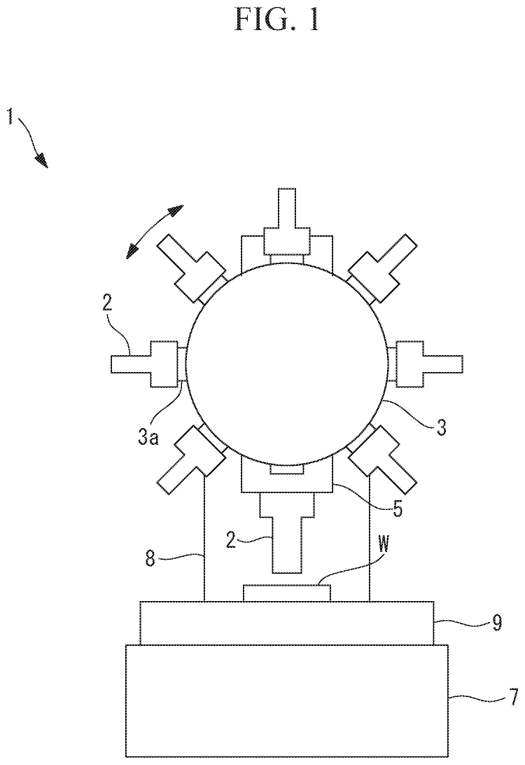

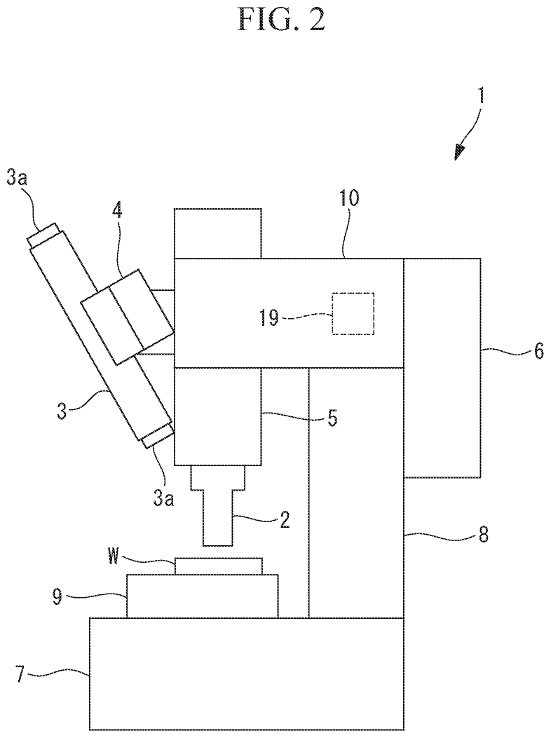

As shown in FIGS. 1 and 2, the machine tool 1 includes: a turret 3 that holds a plurality of tools 2; a rotary motor (drive unit) 4 that rotates the turret 3; a spindle 5 that selectively holds one of the plurality of tools 2 held by the turret 3; and a control device 6 that controls the operation of the turret 3 and the spindle 5.

The turret 3 is supported on an upper end portion of a column 8 extending vertically upward from a bed 7. A table 9, onto which a workpiece W is fixed, is mounted on the bed 7. The spindle 5 is supported on a spindle mounting base 10 so as to be rotatable about a longitudinal axis of the spindle 5, and the spindle mounting base 10 is supported on the column 8, by means of a ball screw and a linear guide or the like, so as to be movable in the vertical direction. The bed 7 is provided with an X-axis feed motor (not shown) and a Y-axis feed motor (not shown) for moving the table 9 in horizontal directions. The column 8 is provided with a Z-axis feed motor 19 for moving the spindle mounting base 10 together with the spindle 5 in the vertical direction.

The machine tool 1 relatively moves the table 9 and the spindle 5 by means of the X-axis, Y-axis, and Z-axis feed motors, while rotating the spindle 5 about the longitudinal axis by means of a spindle motor (not shown). By doing so, the workpiece W and the rotating tool 2 are relatively moved, and thus, the workpiece W is processed by the rotating tool 2.

The machine tool 1 has a function for automatically exchanging tools 2 between the turret 3 and the spindle 5.

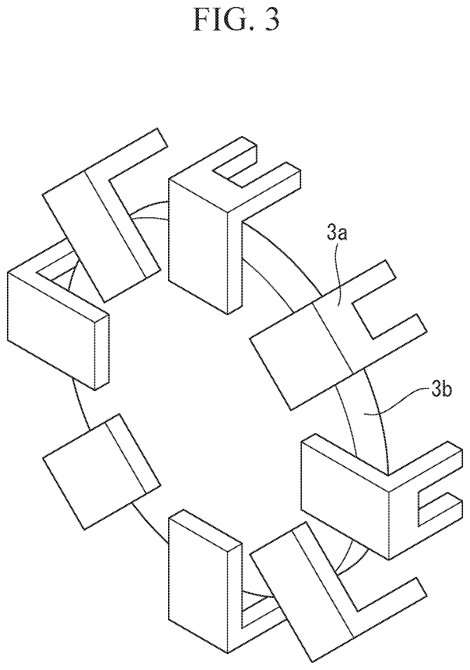

As shown in FIG. 3, the turret 3 includes a plurality of tool holders 3a that are fixed to a peripheral edge portion of a circular rotary plate 3b. The plurality of tool holders 3a are arranged in a circumferential direction of the rotary plate 3b, and each of the tool holders 3a can hold one tool 2. The individual tool holders 3a are provided with identification information. The rotary motor 4 is, for example, a servomotor. The turret 3 is rotated about a central axis of the rotary plate 3b by means of the rotary motor 4, whereby one of the plurality of tool holders 3a is selectively positioned at a prescribed tool exchange position. The machine tool 1 replaces the tool 2 held by the spindle 5 by exchanging the tools 2 between the tool holder 3a at the tool exchange position and the spindle 5.

The turret 3 is rotated by means of the rotary motor 4, whereby one of the plurality of tool holders 3a is selectively positioned at a prescribed tool attachment/removal position. The tool attachment/removal position is a position where a worker or a robot performs attachment of a tool 2 to a tool holder 3a and removal of a tool 2 from a tool holder 3a.

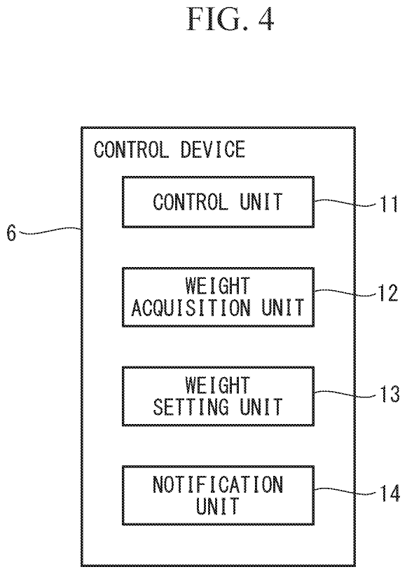

As shown in FIG. 4, the control device 6 includes: a control unit 11 that controls the operation of the turret 3 and the spindle 5; a weight acquisition unit 12 that acquires the weights of the individual tools 2 held by the turret 3; and a weight setting unit 13 that sets the weights of the individual tools 2 in the control unit 11. The control unit 11, the weight acquisition unit 12, and the weight setting unit 13 each include a processor and a storage unit having a non-volatile storage, ROM, RAM, etc., and respectively execute processing, which will be described later, in accordance with programs stored in the storage units.

The control unit 11 controls the operation of the turret 3, the spindle 5, and the table 9 in accordance with control parameters by transmitting control commands to the spindle motor, the feed motors, and the rotary motor 4, and causes processing of the workpiece W by the tool 2 and exchange of the tools 2 between the spindle 5 and the turret 3 to be executed. As will be described later, the control parameter for at least one of the turret 3 and the spindle 5 is set on the basis of the weights of the individual tools 2, which are set by the weight setting unit 13.

Every time one tool 2 is attached to any one of the tool holders 3a, the control unit 11, the weight acquisition unit 12, and the weight setting unit 13 execute acquisition and setting of the weight of the attached tool 2.

Specifically, the control unit 11 causes the turret 3 to rotate in a prescribed operating pattern by transmitting a control command to the rotary motor 4. In the prescribed operating pattern, the turret 3 accelerates, at the start of rotation, to a prescribed rotational speed at a prescribed acceleration and decelerates, at the end of rotation, from the prescribed rotational speed at the prescribed acceleration.

The weight acquisition unit 12 estimates the weight of one tool 2 attached to a tool holder 3a on the basis of a load on the rotary motor 4 while the turret 3 is rotating in the prescribed operating pattern. A method of estimating the weight will be described later.

The weight setting unit 13 stores the weight of the tool 2, which is estimated by the weight acquisition unit 12, in the storage unit of the control unit 11 in association with the identification information of the tool holder 3a, thereby setting the weight of the tool 2 in the control unit 11. Therefore, information about the weights of all tools 2 held by the turret 3 is accumulated in the control unit 11. The weight of a tool 2 may be set in the control unit 11 in association with the identification information of said tool 2. The identification information of a tool 2 is, for example, input to the control device 6 by a worker or is automatically acquired from a recording medium attached to the tool 2.

The acquisition and setting of the weight are executed, for example, after attachment of a tool 2 to a tool holder 3a is completed, in response to an instruction input to the control device 6 by a worker.

The weight setting unit 13 may set, instead of the weight, an index associated with the weight in the control unit 11. For example, in a case in which the maximum allowable weight of a tool 2 that can be mounted on the turret 3 is 4 kg, the index is a numerical value indicating a weight class, i.e. “1”, “2”, “3”, or “4”. The “1” indicates a range of 1 kg or less, the “2” indicates a range of more than 1 kg and at most 2 kg, the “3” indicates a range of more than 2 kg and at most 3 kg, and the “4” indicates a range of more than 3 kg and at most 4 kg.

Next, the operation of the machine tool 1, related to setting of the weight of a tool 2, will be described with an example case where tools 2 are attached, one by one, to the turret 3 in which all of the tool holders 3a are empty.

A first tool 2 is attached by a worker to a tool holder 3a at the tool attachment/removal position. After attachment of the first tool 2, acquisition and setting of the weight of the attached tool 2 to be measured are executed.

Specifically, the rotary motor 4 causes the turret 3 to rotate in the prescribed operating pattern. The weight acquisition unit 12 records load data indicating changes in the load on the rotary motor 4 during rotation of the turret 3. For example, the weight acquisition unit 12 receives a current value of the rotary motor 4 from an ammeter connected to the rotary motor 4, and records time series data of a load torque calculated from the current value as the load data.

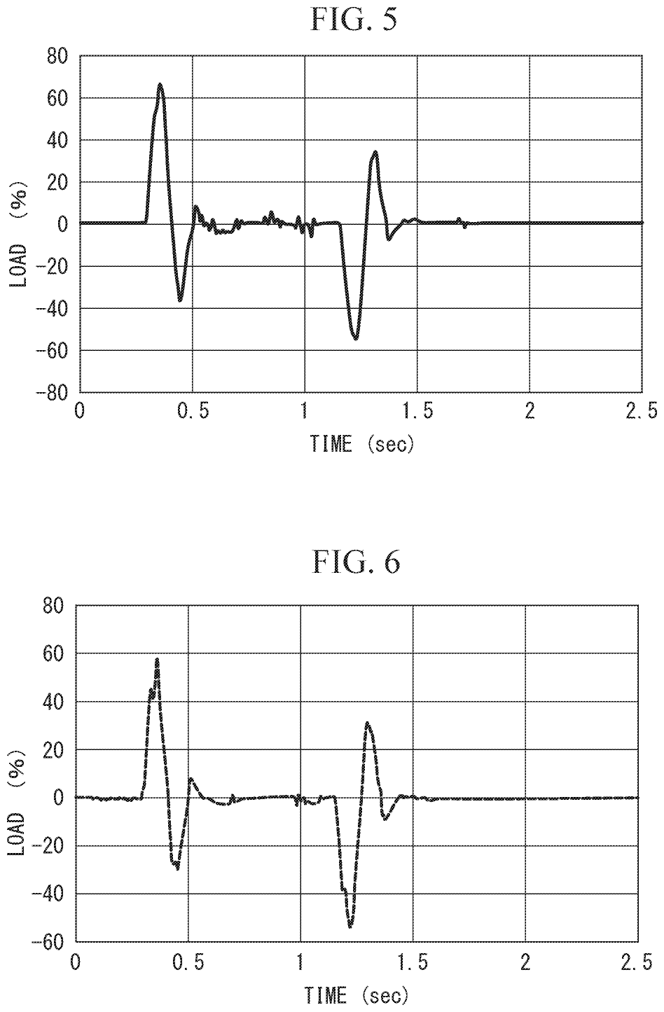

Next, the weight acquisition unit 12 estimates the weight of the tool 2 to be measured by comparing the load data with reference data. The reference data is load data obtained when the turret 3 that holds only one tool 2 having a known reference weight is rotated in the prescribed operating pattern. The reference data is stored in advance, for example, in the storage unit of the weight acquisition unit 12. FIG. 5 shows reference data in a case in which the reference weight is 1 kg. A plurality of reference data sets for a plurality of reference weights may be stored.

FIG. 6 shows load data obtained in a state in which one 1 kg tool 2 is held by the turret 3. As shown in FIG. 6, load data equal to or substantially equal to the reference data is obtained in a case in which the weight of the tool 2 to be measured is equal to the reference weight.

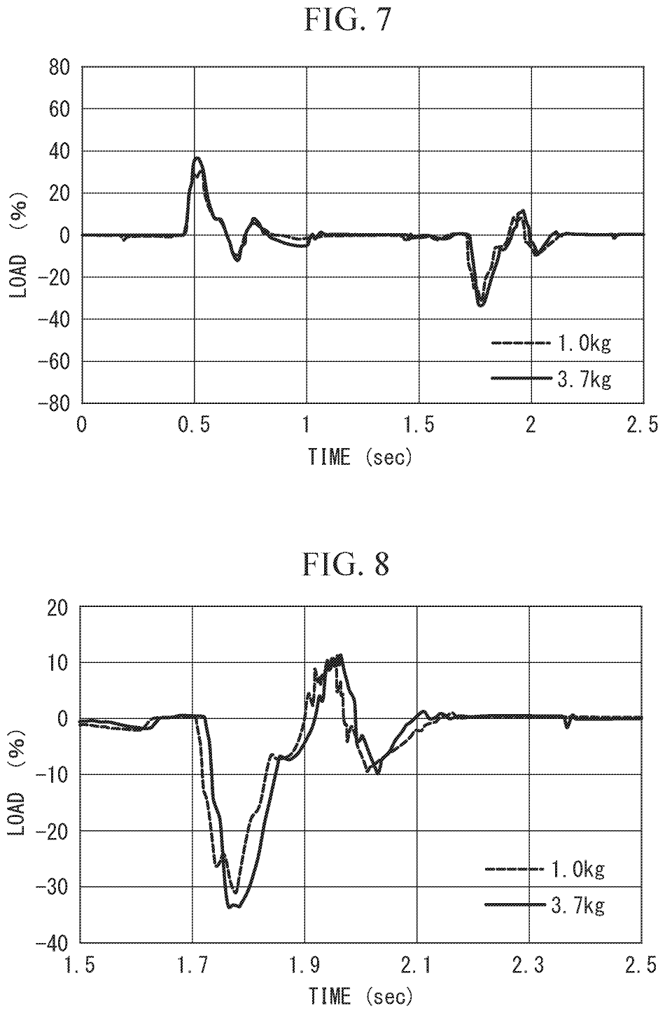

As shown in FIG. 7, the load on the rotary motor 4 increases as the weight of the tool 2 held by the turret 3 increases. FIG. 7 shows load data obtained with a 1.0 kg tool 2 and load data obtained with a 3.7 kg tool 2. In FIG. 8, a portion of the load data in FIG. 7 is enlarged. Therefore, the difference between the load data and the reference data corresponds to the difference between the weight of the tool 2 to be measured and the reference weight. The weight acquisition unit 12 estimates the weight of the tool 2 to be measured on the basis of the difference between the load data and the reference data.

After the weight of the tool 2 to be measured is estimated by the weight acquisition unit 12, the weight setting unit 13 sets the estimated weight or index in the control unit 11 in association with the identification information of the tool holder 3a holding the tool 2 to be measured.

As described above, setting of the weight of the first tool 2 is thus completed.

Next, another empty tool holder 3a is positioned at the tool attachment/removal position by rotation of the turret 3, and a second tool 2 is attached by the worker to the tool holder 3a at the tool attachment/removal position. After attachment of the second tool 2, acquisition and setting of the weight of the second tool 2 are executed in the same way as for the first tool 2. The load data recorded at the second time by the weight acquisition unit 12 is load data based on the weights of the first and second tools 2. The weight acquisition unit 12 estimates the weight of the second tool 2 on the basis of the difference between the first load data and the second load data. The weight acquisition unit 12 may estimate the weight of the second tool 2 on the basis of the difference between the reference data and the second load data, as well as the weight of the first tool 2 which is already estimated.

Next, another empty tool holder 3a is positioned at the tool attachment/removal position by rotation of the turret 3, and a third tool 2 is attached by the worker to the tool holder 3a at the tool attachment/removal position. After attachment of the third tool 2, acquisition and setting of the weight of the third tool 2 are executed in the same way as for the first tool 2. The weight acquisition unit 12 estimates the weight of the third tool 2 on the basis of the difference between the second load data and the third load data.

Thereafter attachment of a tool 2 to an empty tool holder 3a, and acquisition and setting of the weight of the tool 2 are repeated.

After the weights of all the tools 2 held by the turret 3 are set, the control unit 11 sets a control parameter for at least one of the turret 3 and the spindle 5 on the basis of the weights of the individual tools 2, which are set by the weight setting unit 13, and executes processing of the workpiece W and exchange of the tools 2.

An example of the control parameter is the speed at which the spindle 5 is vertically moved by means of the Z-axis feed motor 19 during tool exchange. When the tools 2 are exchanged between the turret 3 and the spindle 5, the spindle mounting base 10 and the spindle 5 are vertically moved with respect to the turret 3 by means of the Z-axis feed motor 19. The control unit 11 sets the moving speed of the spindle 5 and the spindle mounting base 10 such that the moving speed of the spindle 5 becomes higher as the tool 2 held by the spindle 5 becomes lighter. By doing so, it is possible to reduce the time required for the tool exchange.

Another example of the control parameter is the speed at which the turret 3 is rotated by means of the rotary motor 4. The inertia of the tool 2 becomes larger as the tool 2 becomes heavier and as the rotation of the turret 3 becomes faster. The control unit 11 sets the rotational speed of the turret 3 such that the rotational speed becomes lower as the maximum weight among the weights of the tools 2 held by the turret 3 becomes larger. By doing so, it is possible to prevent a heavy tool 2 from being detached from the tool holder 3a due to inertia and falling from the turret 3 or being damaged.

As described above, every time one tool 2 is attached to the turret 3, the machine tool 1 automatically acquires and sets the weight of the attached tool 2, and sets control parameters in accordance with the weights of the individual tools 2. Therefore, even in a case in which tools 2 having various weights are held by the turret 3, it is possible to set appropriate control parameters in accordance with the weights of the individual tools 2. Because a decision by a worker is not required for setting the weights and the control parameters, even in a case in which an inexperienced worker attaches a tool 2 to the turret 3, it is possible to set appropriate control parameters in accordance with the weight of the tool 2 and to prevent the occurrence of a problem such as the tool 2 falling off.

Although the case where a tool 2 is attached to the turret 3 in which all of the tool holders 3a are empty has been described in the abovementioned embodiment, the weight of a tool 2 newly attached to the turret 3 may be acquired and set after any one of the plurality of tools 2 held by the turret 3 is replaced therewith.

The machine tool 1 may further include a notification unit 14 that notifies a worker in a case in which the weight of a tool 2, which is acquired by the weight acquisition unit 12, exceeds a prescribed allowable value. The notification unit 14 is, for example, a display that displays an alarm indication or an alarm device that issues an alarm sound.

With this configuration, the worker can recognize that the weight of the tool 2 attached to the tool holder 3a exceeds the allowable value, on the basis of the output of the notification unit 14. Thus, it is possible to prevent the machine tool 1 from using a tool 2 having a weight exceeding the allowable value. In order to prevent the machine tool 1 from operating in a state in which a tool 2 having a weight exceeding the allowable value is held by the turret 3, the control unit 11 may prohibit the operation of the turret 3, the spindle 5, the table 9, etc. in the case in which a tool 2 having a weight exceeding the allowable value is attached to a tool holder 3a.

In the abovementioned embodiment, the control device 6 may include a learning unit that learns the relationship between the load on the rotary motor 4 and the weight estimated from the load by the weight acquisition unit 12.

For example, the load data and the weight of a tool 2, which is calculated from the load data, are accumulated in the storage unit of the control unit 11. The control unit 11 serving as the learning unit learns the relationship between the accumulated load data and weight on the basis of a learning program stored in the storage unit. The weight acquisition unit 12 estimates the weight a tool 2 by using a learning result of the learning unit. By doing so, it is possible to enhance the precision for estimating the weight by the weight acquisition unit 12.

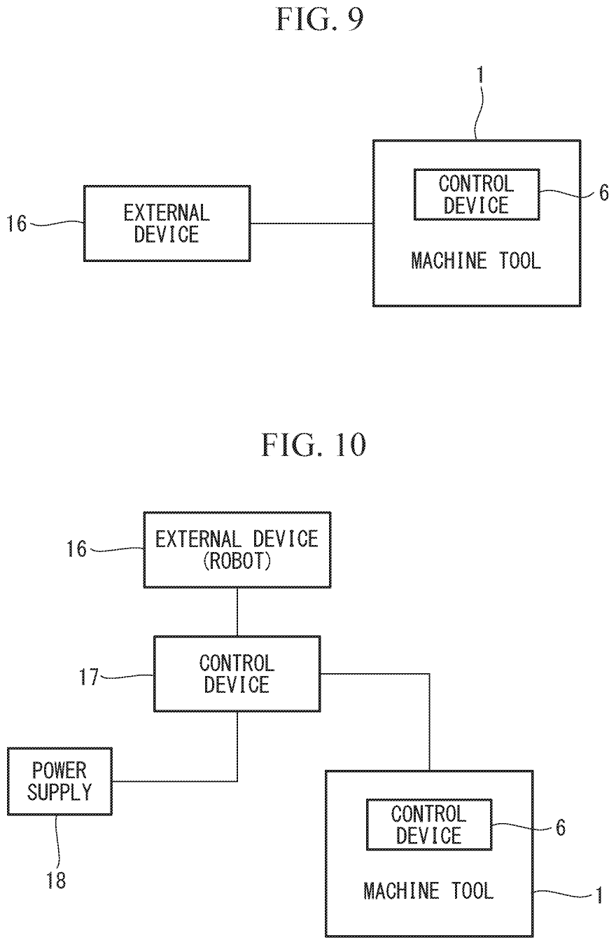

Although the weight acquisition unit 12 estimates the weight of a tool 2 on the basis of the load on the rotary motor 4 in the abovementioned embodiment, alternatively, as shown in FIG. 9, the weight acquisition unit 12 may receive the weight of a tool 2 attached to a tool holder 3a or information about the weight from an external device 16.

An example of the external device 16 is a gravimeter that measures the weight of a tool 2. For example, the gravimeter is disposed outside the machine tool 1 and is connected to the control device 6 so as to be able to communicate therewith. The worker measures the weight of a tool 2 by using the gravimeter, and subsequently attaches the tool 2 to a tool holder 3a. The measurement of the weight of a tool 2 by means of the gravimeter may be performed by a robot that attaches/removes a tool 2 to/from the turret 3. The weight of the tool 2 is transmitted to the weight acquisition unit 12 from the gravimeter.

Another example of the external device 16 is a robot that attaches/removes a tool 2 to/from the turret 3. For example, the robot is provided with: an articulated robot arm; a hand that is connected to the distal end of the robot arm; and a force sensor that detects a load acting on the hand. The robot detects a load acting on the hand, in other words, the weight of a tool 2 by means of the force sensor, in a state in which the tool 2 is gripped by the hand, and transmits the detected weight of the tool 2 to the weight acquisition unit 12. Another embodiment of the present disclosure may be a processing system including the machine tool 1 and such a robot as described above.

Another example of the external device 16 is a control device of another machine tool that is connected to the control device 6. The weight acquisition unit 12 receives the weight of a tool, which is stored in the control device of the other machine tool, together with the identification information of the tool from the control device of the other machine tool. The control device 6 may transmit, to the control device of the other machine tool, the weight of a tool 2 together with the identification information thereof. Thus, by sharing the information about the weight of a tool 2 between a plurality of machine tools, the control devices of the individual machine tools can efficiently collect the information about the weights of various tools 2.

Although setting of the weight of a tool 2 in the control unit 11 is executed in the control device 6 of the machine tool 1 in the abovementioned embodiment, alternatively, a control device different from the control device 6 may set the weight of a tool 2 in the control unit 11. FIGS. 10 to 12 show other embodiments.

In another embodiment shown in FIG. 10, the machine tool 1 is connected to the external device 16 via another control device 17 different from the control device 6. The other control device 17 is, for example, a microcomputer that is disposed inside or outside the machine tool 1. The weight acquisition unit 12 and the weight setting unit 13 are provided in the other control device 17. The other control device 17 acquires the information about the weight of a tool 2 from the external device 16, and sets the weight of the tool 2 in the control unit 11 of the control device 6. Thus, the connection between the external device 16 and the machine tool 1 is relayed by the other control device 17, and this makes it possible to simplify the wiring.

The other control device 17 may be connected to a power supply 18 different from a power supply of the machine tool 1. With this configuration, it is possible to enhance the maintenance workability of the machine tool 1. For example, even when the power supply of the machine tool 1 is turned off, the worker can check, with the other control device 17, the weight of a tool 2 held by the turret 3.

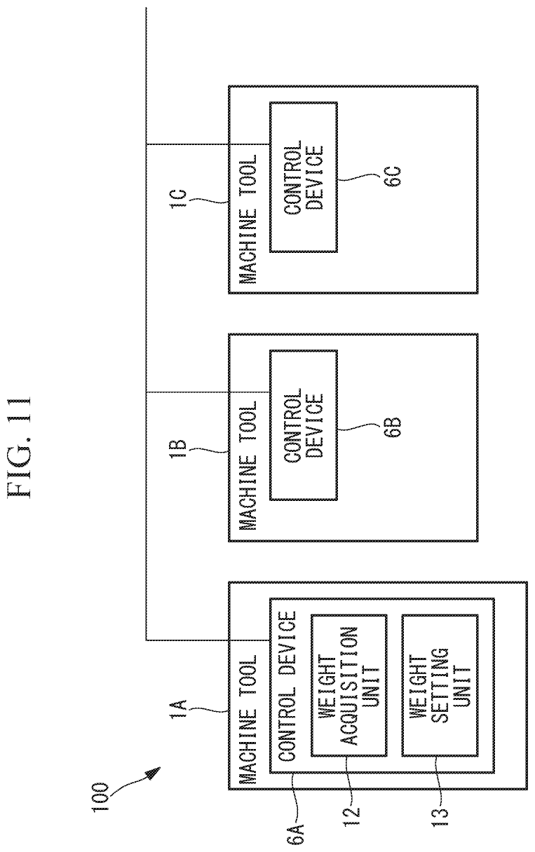

FIG. 11 shows a management system 100 according to another embodiment. The management system 100 includes a plurality of machine tools 1A, 1B, 1C. A control device 6A of one machine tool 1A is connected to control devices 6B, 6C of other machine tools 1B, 1C and monitors the other machine tools 1B, 1C. The control device 6A includes the weight acquisition unit 12 and the weight setting unit 13, and sets the weight of a tool 2 in respective control units 11 of the control devices 6A, 6B, 6C. By doing so, it is possible to set control parameters in accordance with the weights of the individual tools 2 held by the turret 3 also in the machine tools 1B, 1C that do not include the weight acquisition unit 12 and the weight setting unit 13.

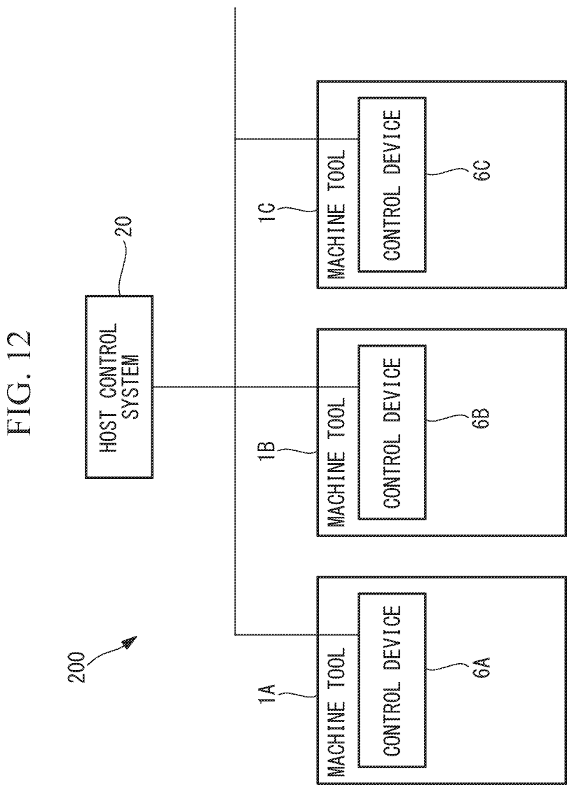

FIG. 12 shows a management system 200 according to another embodiment. The management system 200 includes a plurality of machine tools 1A, 1B, 1C and a host control system (control device) 20. In the management system 200, control devices 6A, 6B, 6C and the external device 16 are edge devices, and the host control system 20 is connected to the control devices 6A, 6B, 6C of the plurality of machine tools 1A, 1B, 1C and the external device 16. The host control system 20 includes the weight acquisition unit 12 and the weight setting unit 13, and sets the weight of a tool 2 in respective control units 11 of the control devices 6A, 6B, 6C. By doing so, with one host control system 20, it is possible to set control parameters of the plurality of machine tools 1A, 1B, 1C in accordance with the weights of the individual tools 2 held by the turret 3.

The host control system 20 is, for example, a computer connected to the control devices 6A, 6B, 6C by wires or a computer or the like disposed within the same site as the control devices 6A, 6B, 6C. The host control system 20 is sometimes referred to as a fog computer. The host control system 20 may be a production management system, a delivery management system, a robot management system, a department management system or the like. The host control system 20 includes: a control unit having a processor or the like; a display device; a storage unit having a non-volatile storage, ROM, RAM, etc.; an input device which is a keyboard, a touch panel, an operation panel or the like; and so forth.

In the management systems 100, 200 in FIGS. 11 and 12, the information about the loads on rotary motors 4 and the estimated weights of the tools 2 in the plurality of machine tools 1A, 1B, 1C is aggregated in the common control device 6A or 20. This configuration is advantageous in that it is possible to enhance the learning efficiency in a case in which the control devices 6A, 20 have a learning function similar to that of the aforementioned learning unit of the control device 6.

In the management systems 100, 200 in FIGS. 11 and 12, the plurality of control devices 6A, 6B, 6C may each have a learning function. In this case, for example, the host control system 20 may transmit, as learning data, the aggregated information about the loads on the rotary motors 4 and the estimated weights of the tools 2 to the individual control devices 6A, 6B, 6C.

A plurality of host control systems 20 may be connected to another host control system. The other host control system is, for example, a cloud server connected to the plurality of host control systems 20 via a wired or wireless communication network. In this case, the other host control system may set the weight of a tool 2 in the control units 11 of the machine tools 1A, 1B, 1C serving as edge devices. The other host control system may have a learning function.

### REFERENCE SIGNS LIST

1 machine tool
2 tool
3 turret
3a tool holder
4 rotary motor (drive unit)
5 spindle
6 control device
11 control unit (learning unit)
12 weight acquisition unit
13 weight setting unit
14 notification unit
16 external device, gravimeter, robot, control device
17 control device, microcomputer
20 host control system (control device)

1. A machine tool comprising:
a turret capable of holding a plurality of tools;
a spindle that selectively holds one of the plurality of tools held by the turret;
a control unit that controls the operation of the turret and the spindle in accordance with a control parameter;
a weight acquisition unit that, every time one tool is attached to the turret, acquires a weight of the attached one tool;
a weight setting unit that sets the weight acquired by the weight acquisition unit or an index associated with the weight in the control unit in association with the attached one tool; and
wherein the control unit sets the control parameter on the basis of the weights of the individual tools, which are set by the weight setting unit.

2. The machine tool according to claim 1, further comprising:
a drive unit that rotates the turret; and
wherein the weight acquisition unit estimates the weight of the attached one tool on the basis of a load on the drive unit when the turret is rotated.

3. The machine tool according to claim 1, wherein the weight acquisition unit receives the weight of the attached one tool or information about the weight from an external device.

4. The machine tool according to claim 3, wherein the external device is a gravimeter that measures the weight of the tool.

5. The machine tool according to claim 3, wherein the external device is a robot that attaches/removes a tool to/from the turret.

6. The machine tool according to claim 3, wherein the external device is a control unit of another machine tool connected to the control unit.

7. The machine tool according to claim 3, further comprising: a control device that connects the control unit and the external device,
wherein the weight acquisition unit and the weight setting unit are provided in the control device.

8. The machine tool according to claim 1, wherein the control unit sets, as the control parameter, at least one of a rotational speed of the turret and a moving speed of the spindle.

9. The machine tool according to claim 1, further comprising a notification unit that notifies a worker in a case in which the weight acquired by the weight acquisition unit exceeds a prescribed allowable value.

10. The machine tool according to claim 2, further comprising:
a learning unit that learns a relationship between a load on the drive unit and the weight estimated from the load by the weight acquisition unit; and
wherein the weight acquisition unit estimates the weight by using a learning result of the learning unit.

11. A processing system comprising:
the machine tool according to claim 1; and
a robot that attaches/removes a tool to/from the turret of the machine tool.

12. A management system comprising:
a machine tool including a turret capable of holding a plurality of tools, a spindle that selectively holds one of the plurality of tools held by the turret, and a control unit that controls the operation of the turret and the spindle in accordance with a control parameter;
a control device that is connected to the control unit;
wherein the control device includes:
a weight acquisition unit that, every time one tool is attached to the turret, acquires a weight of the attached one tool; and
a weight setting unit that sets the weight acquired by the weight acquisition unit or an index associated with the weight in a control unit of the machine tool in association with the attached one tool; and
wherein the control unit of the machine tool sets the control parameter on the basis of the weights of the individual tools, which are set by the weight setting unit.

13. The management system according to claim 12, comprising:
a plurality of machine tools; and
wherein the control device is a control device of any one of the plurality of machine tools.

14. The management system according to claim 12, comprising:
a plurality of machine tools;
a host control system connected to the plurality of machine tools; and
wherein the control device is the host control system, and sets the weight of the tool in respective control units of the plurality of machine tools.
